(19) United States
(12) Patent Application Publication
(10) Pub. No.: US 2014/0201942 A1
(43) Pub. Date: Jul. 24, 2014

(54) WHEEL-SUPPORTING ARRANGEMENT

(71) Applicants: Mohammed Irfan, West Yorkshire (GB); David Cottrell, Birmingham (GB)

(72) Inventors: Mohammed Irfan, West Yorkshire (GB); David Cottrell, Birmingham (GB)

(21) Appl. No.: 14/116,569

(22) PCT Filed: May 11, 2012
(86) PCT No.: PCT/GB2012/051056

§ 371 Date: Feb. 7, 2014

(30) Foreign Application Priority Data
May 11, 2011 (GB) 1107862.3

(51) Int. Cl. A47L 9/00; B60B 33/00; A47L 9/12

(52) U.S. Cl. CPC A47L 9/009; A47L 9/122; B60B 33/0002
USPC 15/347; 15/300.1; 16/40; 16/45

(57) ABSTRACT

An arrangement for supporting a wheel for rotation about an axis, comprising a wheel carrier part having an at least partially annular carrier formation extending therefrom generally in the direction of the axis, a wheel encircling at least part of the carrier formation and a retaining member releasably engaging the carrier part and affording a bearing surface with which a complementary bearing surface of the wheel co-operates to support the wheel for said rotation.

This invention relates to a wheel-supporting arrangement. The invention has been devised for supporting a wheel of a suction cleaner (“vacuum cleaner”), wherein specific design features may be present as described hereafter, but in being suitable for such use it will be appreciated that the invention may be usable elsewhere, for example in other domestic appliances.

In modern vacuum cleaners, of the “cylinder” or “canister” type, it is common to provide wheels of relatively large diameter, e.g. 100 mm to 150 mm, or more, at or towards one end of the cleaner. This is usually the end at which the electric motor and suction-airflow creating fan or impeller of the machine are disposed, these being the heaviest single components of a mains electrically-powered vacuum cleaner, while a suction hose connects to the cleaner at the opposite end of the cleaner. Such large wheels render it easy for the cleaner to pass over obstructions such as door thresholds, when being pulled over a floor surface by a user holding either the end of the cleaner's suction hose remote from the cleaner, or a cleaning tool or wand attached to that end of the hose. At the end of the cleaner from which the hose extends, one or more smaller wheels or castors may be provided, which are easily lifted over a threshold by pulling on the suction hose. One design feature which has been adopted in such cleaners is to provide for the exhaust airflow of the cleaner to take place through the centre of one of the large-diameter wheels of the cleaner, usually with the provision of an exhaust filter in the wheel or in the body of the cleaner immediately inboard of the wheel; this renders it difficult to support the wheel rotationally on a simple axle or spindle component since such a component would have to be disposed in the space occupied by the exhaust airflow duct and/or filter. Accordingly, some other wheel-supporting arrangement would have to be provided. At the same time; the number of components required is, desirably, minimised, in the interests of economical manufacture It is broadly the object of the present invention to address these requirements.

According to one aspect of the invention, we provide an arrangement for supporting a wheel for rotation about an axis, comprising:

a wheel carrier part having an at least partially annular carrier formation extending therefrom generally in the direction of the axis;

a wheel member encircling at least part of the carrier formation; and

a retaining member releasably engaging the carrier part and affording a bearing surface with which a complementary bearing surface of the wheel co-operates to support the wheel for said rotation.

The carrier formation and wheel are preferably adapted to co-operate to hold the wheel on the carrier formation when the wheel is placed thereon. To this end the carrier formation and wheel may have respective formations which snap into engagement with one another when the wheel is placed on the carrier formation. When thus fitted, the wheel preferably is rotatable about the carrier formation, even prior to the retaining member being fitted. However, when the retaining member is fitted to the carrier part, the co-operating formations of the wheel and carrier formation are preferably held out of contact with one another, so that they do not interfere with the ability of the wheel to rotate by virtue of its complementary bearing surface engaging the bearing surface of the retaining member.

Preferably the bearing surface of the retaining member faces radially outwardly, and the bearing surface of the wheel radially inwardly.

The retaining member may have bayonet-type engagement with the wheel carrier part.

The carrier formation may substantially encircle an opening in the wheel carrier part, which opening forms an end part of an air-flow duct. The duct may be adapted to receive a filter element.

The filter element may be retained in position in the opening by the retaining member.

The invention further provides a vacuum cleaner provided with a wheel assembly according to the first aspect of the invention as above set forth. In this case, the airflow duct may provide for exhaust airflow from the motor/fan of the cleaner.

These and other features of the invention will now be described by way of example with reference to the accompany drawings, of which:

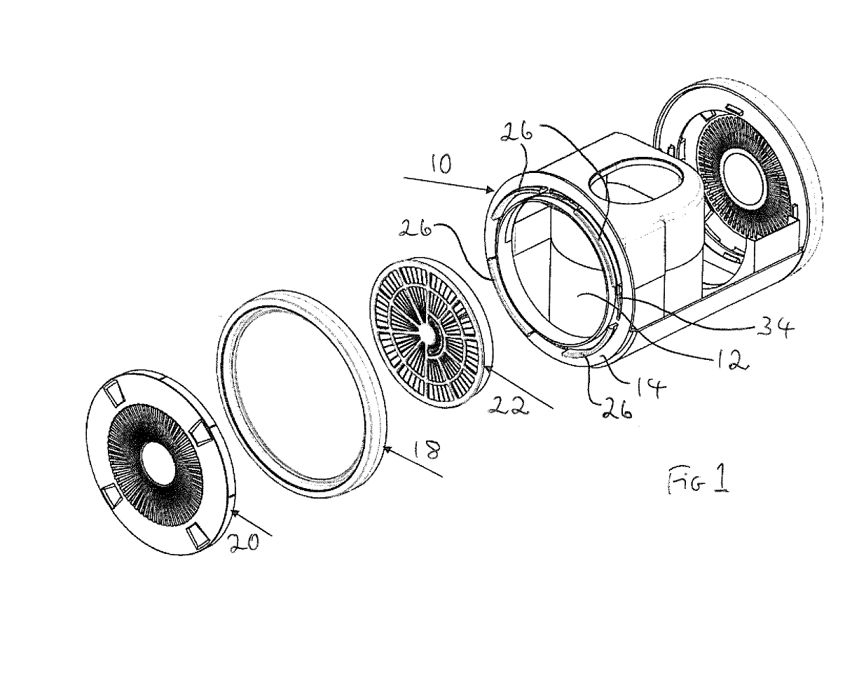

FIG. 1 is an exploded perspective view of a wheel-supporting arrangement, for a vacuum cleaner, in accordance with the invention;

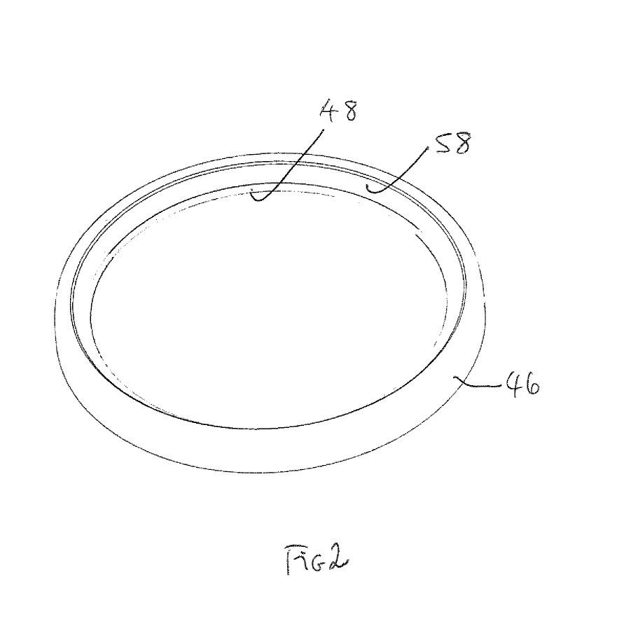

FIG. 2 shows, in perspective, the wheel of the arrangement;

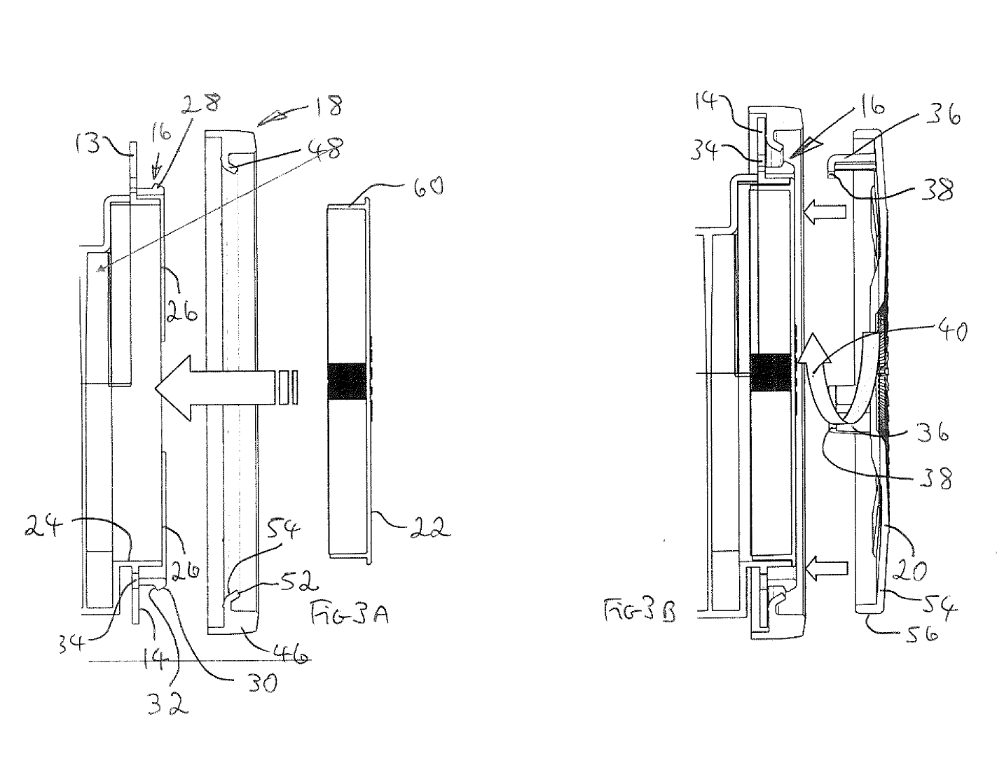

FIGS. 3A and 3B illustrate stages of assembly of the arrangement; and

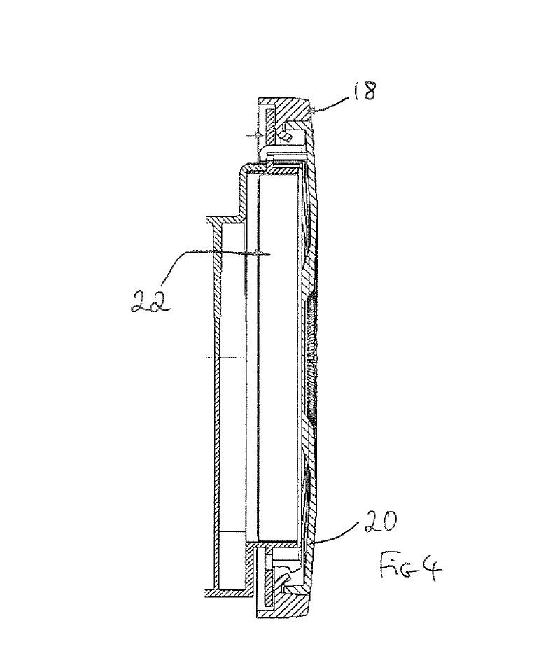

FIG. 4 is an enlargement showing, in section, part of the arrangement.

Referring firstly to FIG. 1 of the drawings, this shows, in exploded relationship, a wheel carrier part indicated generally at 10, of a vacuum cleaner. This is a moulded plastics component which constitutes the lower part of the external housing of a cylinder-type vacuum cleaner, and incorporates a part-circular wall formation 12 upstanding internally of the housing from a lower surface of the housing (which lies adjacent the ground on which the cleaner stands in use). The wall formation 12 accommodates an electric motor, not shown, for driving a fan for creating the suction airflow of the cleaner. The exhaust airflow from the motor and fan is delivered into the interior of the housing outside the wall formation 12. Alongside the wall formation 12 the carrier part has an annular wall 13 with a laterally facing annular surface 14 from which a carrier formation 16 (described in greater detail hereafter), extends outwardly, to carry a wheel 18, a retaining member 20, and a filter assembly indicated generally at 22.

The carrier part 10 includes an inner annular wall 24 surrounding an opening leading to the space within the housing of the vacuum cleaner, adjacent the wall 12. Annular surface 14 extends radially outwardly from the wall 24, and spaced outwardly from the wall 24, extending axially from the surface 14, there is the carrier formation 16. This has four arcuate portions 26 equally circumferentially spaced from one another, each of which when viewed in section has, adjacent its free end, a lip formation 28 with a part-frusto-conical front surface 30 and a further, oppositely facing, frusto-conical rear surface 32 (references to radial and axial herein refer to the central longitudinal axis of the opening defined by the wall 24, which axis is also the axis of rotation of the wheel 18 in use). Between the arcuate portions 26 with their respective lip formations 28, the inner annular wall 24 has respective portions 34 for bayonet-fashion engagement by respective parts of the retaining member 20. In each of the portions 34, a respective inturned foot 38 at the free end of a respective leg formation 36, extending axially rearwardly from the retaining member 20, is able to extend through an opening in the wall 13 and, by a small angular movement of the retaining member 20 as indicated by arrow 40 in FIG. 3B, to engage behind an abutment surface, thereby holding the retaining member in position relative to the carrier part 10.

The configuration of wheel 18 is shown in FIG. 2. The wheel has a radially outermost portion 46, whose outer surface contacts the floor or other surface on which the vacuum cleaner is standing, and an inner portion 48 in the form of a wall extending axially outwardly, and radially at an inward inclination, from the portion 46. In section, the inner portion 48 has an end face which is part-frusto-conical 52 and an inner surface 54, also frusto-conical, in opposition to the surfaces 32, 30 of lip formations 28 on the respective arcuate carrier formation parts 26. The dimensions of the respective formations are such that the wheel is able to be press-fitted axially onto the carrier formation 16, deforming the respective parts 26 provided with the lip formations until the wheel snap-fits into the position in which it is shown in FIG. 4. In this position, the wheel is retained to the housing of the cleaner, and is able to rotate thereabout. The wheel is provided with formations such as small ‘pips’ or ribs where appropriate, to reduce friction at its running surfaces.

As above described, the retaining member 20 is provided with legs 36 and feet 38 at the free ends thereof, which are bayonet-fit engageable with the portions 34 of the wall 24, to hold the retaining member in position. The retaining member 20 further comprises a circular body 54 whose outer circumference has a bearing surface 56 engageable with a running bearing surface 58 provided in the wheel 18, so that when the retaining member is in situ the wheel is supported for rotation about its axis primarily by the engagement between the complementary bearing surfaces 56, 58, rather than by engagement between the formations 30, 32 and 52, 54.

The filter 22 comprises a filter element of any suitable type supported within a plastics frame 60. The frame 60 fits closely within the annular wall 24, and the filter is held in position therein when the retaining member 20 has been engaged with the vacuum cleaner housing, as above described.

The above described wheel-supporting arrangement has, compared with some other proposed designs for such an arrangement, relatively few components, and therefore is economical in manufacture. Even if the retaining member 20 is removed, e.g. for maintenance or replacement of the filter 22, the wheel remains in situ, held to the vacuum cleaner housing, and is rotatable.

All the above-described components may be made of suitable plastics materials. The fact that the co-operating bearing surfaces by which the wheel is supported for rotation are provided on the wheel itself and the retaining member means that suitable plastics materials for this purpose can be selected, which materials might not be so well suited for manufacture of, for example, a housing component of a vacuum cleaner. Thus, by way of example, the housing components of a cleaner may be of ABS which has good aesthetic qualities, while a more durable and/or self-lubricating plastics material(s) may be used for the wheel and retaining member.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. An arrangement for supporting a wheel for rotation about an axis, comprising:
a wheel carrier part (10, 13) having an at least partially annular carrier formation (16) extending therefrom generally in the direction of the axis;
a wheel (18) encircling at least part of the carrier formation; and
a retaining member (20) releasably engaging the carrier part and affording a bearing surface (56) with which a complementary bearing surface (58) of the wheel co-operates to support the wheel for said rotation.

2. An arrangement according to claim 1 wherein the carrier formation and wheel are adapted to co-operate to hold the wheel in situ when thus placed.

3. An arrangement according to claim 2 wherein the carrier formation and wheel have respective formations (48, 28) which snap into engagement with one another when the wheel is placed in situ.

4. An arrangement according to claim 3 wherein, when the retaining member is fitted, the snap-engagement formations (48, 28) of the carrier formation and wheel are held out of contact with one another.

5. An arrangement according to claim 1 wherein the retaining member has bayonet-type engagement with the wheel carrier part.

6. An arrangement according to claim 1 wherein the carrier formation extends around an opening in the wheel carrier part.

7. An arrangement according to claim 6 wherein the opening forms an end part of an airflow duct.

8. An arrangement according to claim 7 comprising a filter element adapted to be received in the duct and/or opening.

9. An arrangement according to claim 8 wherein the retaining member retains the filter element in position.

10. (canceled)

11. A vacuum cleaner comprising:
a wheel for rotation about an axis;
a wheel carrier part (10, 13) having an at least partially annular carrier formation (16) extending therefrom generally in the direction of the axis;
a wheel (18) encircling at least part of the carrier formation; and
a retaining member (20) releasably engaging the carrier part and affording a bearing surface (56) with which a complementary bearing surface (58) of the wheel co-operates to support the wheel for said rotation.

12. A vacuum cleaner according to claim 11 wherein the carrier formation and wheel are adapted to co-operate to hold the wheel in situ when thus placed.

13. A vacuum cleaner according to claim 12 wherein the carrier formation and wheel have respective formations (48, 28) which snap into engagement with one another when the wheel is placed in situ.

14. A vacuum cleaner according to claim 13 wherein, when the retaining member is fitted, the snap-engagement formations (48, 28) of the carrier formation and wheel are held out of contact with one another.

15. A vacuum cleaner according to claim 11 wherein the retaining member has bayonet-type engagement with the wheel carrier part.

16. A vacuum cleaner according to claim 11 wherein the carrier formation extends around an opening in the wheel carrier part.

17. A vacuum cleaner according to claim 16 wherein the opening forms an end part of an airflow duct.

18. A vacuum cleaner according to claim 17 comprising a filter element adapted to be received in the duct and/or opening.

19. A vacuum cleaner according to claim 18 wherein the retaining member retains the filter element in position.
